(19) United States
(12) Patent Application Publication
(10) Pub. No.: US 2007/0195170 A1
(43) Pub. Date: Aug. 23, 2007

(54) IMAGING APPARATUS CONTROL UNIT AND DIGITAL CAMERA

(75) Inventors: Yasuhiro YAMAMOTO, Tokyo (JP); Daisuke ENOMOTO, Tokyo (JP)

Correspondence Address: GREENBLUM & BERNSTEIN, P.L.C., 1950 ROLAND CLARKE PLACE, RESTON, VA, 20191, US

(73) Assignee: PENTAX CORPORATION, Tokyo (JP)

(21) Appl. No.: 11/676,543

(22) Filed: Feb. 20, 2007

(30) Foreign Application Priority Data
Feb. 21, 2006 (JP) 2006-043974

(51) Int. Cl. H04N 5/225

(52) U.S. Cl. 348/207.99

(57) ABSTRACT

An imaging apparatus control unit that controls an operation of an imaging apparatus, comprising a receiver, a timer, and an imaging device driving unit, is provided. The imaging apparatus comprises an imaging device. The receiver receives an input signal. The input signal is generated when a command is input. The command is for ordering the imaging apparatus to carry out a predetermined function. The timer starts clocking when the receiver receives the input signal. The imaging device driving unit orders the imaging device to capture the optical image once every first interval before the predetermined period of time elapses. The imaging device driving unit orders the imaging device to capture the optical image once every second interval after the predetermined period of time elapses. The second interval is longer than the first interval.

### BACKGROUND OF THE INVENTION

1. Field of the Invention

The present invention relates to an imaging apparatus control unit that controls operations for carrying out a function of an imaging apparatus, such as a digital camera, with such digital camera having the control unit.

2. Description of the Related Art

A digital camera generates and stores electronic data corresponding to an optical image by capturing an object. Power is consumed to generate and store the electronic data. In addition, the digital camera may have various functions, and power is consumed to carry out such functions.

Power used for the above operations of the digital camera is supplied by a battery, such as a storage battery. The capacity of a battery, which can be re-charged, is limited. Accordingly, when power charged in the battery is completely spent, the various functions of the digital camera, including photographing, cannot be carried out.

### SUMMARY OF THE INVENTION

Therefore, an object of the present invention is to provide an imaging apparatus control unit and a digital camera that mitigate power consumption.

According to the present invention, an imaging apparatus control unit, comprising a receiver, a timer, and an imaging device control unit, is provided. The imaging apparatus control unit controls an operation of an imaging apparatus. The imaging apparatus comprises an imaging device. The imaging device captures an optical image of an object. The receiver receives an input signal. The input signal is generated when a command is input to an input block. The command is for ordering the imaging apparatus to carry out a predetermined function. The timer starts clocking a time when the receiver receives the input signal. The imaging device driving unit orders the imaging device to capture the optical image. The optical image is captured once every first interval before the predetermined period of time clocked by the timer elapses. The optical image is captured once every second interval after the predetermined period of time clocked by the timer elapses. The second interval is longer than the first interval.

Further, the time clocked by the timer is reset when the receiver receives a new input signal.

Further, the imaging device driving unit comprises a frame signal generator and a cycle adjustment block. The frame signal generator generates a frame signal. The frame signal determines a frequency per unit time for capturing the optical image. The cycle adjustment block orders the frame signal generator to generate the frame signal of which cycle is the first interval before the predetermined period of time clocked by the timer elapses. The cycle adjustment block orders the frame signal generator to generate the frame signal of which cycle is the second interval after the predetermined period of time clocked by the timer elapses.

### BRIEF DESCRIPTION OF THE DRAWINGS

The objects and advantages of the present invention will be better understood from the following description, with references to the accompanying drawings in which:

FIG. 1 is a block diagram showing the internal structure of a digital camera having an imaging apparatus control unit of an embodiment of the present invention;

FIG. 2 is a flowchart describing the process carried out by the CPU and the AFE when the function for power saving is switched on; and

FIG. 3 is a rear view of the digital camera, displaying a screen indicating the time selection choices for commencing the power saving function on the LCD.

### DESCRIPTION OF THE PREFERRED EMBODIMENTS

The present invention is described below with reference to the embodiment shown in the drawings.

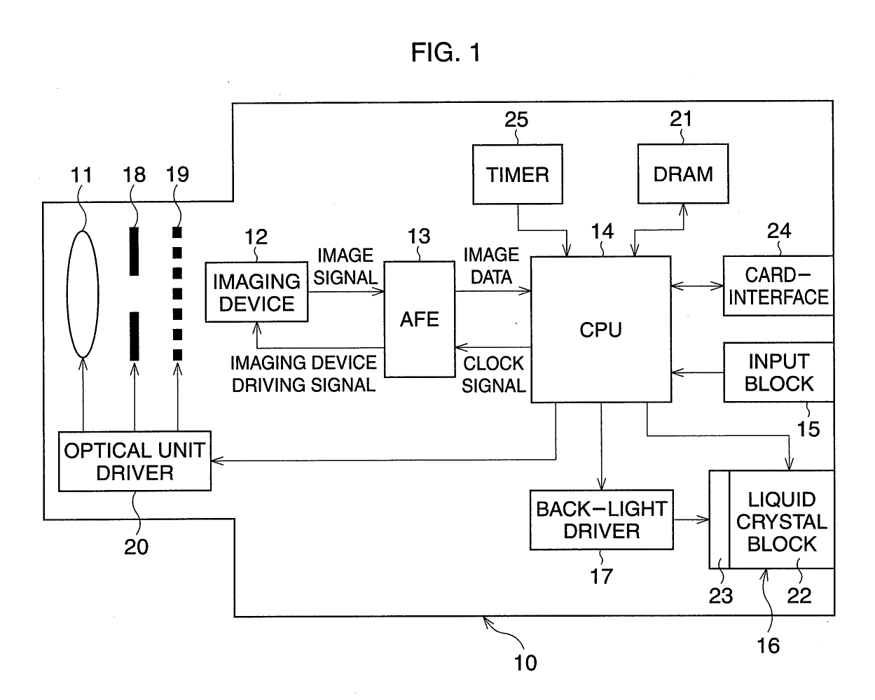

In FIG. 1, a digital camera 10 comprises a photographic optical system 11, an imaging device 12, an analog front end (AFE) 13, a CPU 14, an input block 15, a liquid crystal display (LCD) 16, a back-light driver 17, and other components.

The photographic optical system 11 is optically connected to the imaging device 12. An optical image of an object through the photographic optical system 11 is incident to the light receiving surface of the imaging device 12. The imaging device 12 is, for example, a CCD area sensor. When the imaging device 12 captures the optical image of the object on its light receiving surface, the imaging device 12 generates an image signal corresponding to the captured optical image.

A diaphragm 18 and a shutter 19 are mounted between the photographic optical system 11 and the imaging device 12. The intensity of light, made incident on the light receiving surface of the imaging device 12, is adjusted by changing an aperture ratio of the diaphragm 18. An optical image is exposed to the light receiving surface by opening the shutter 19, and an optical image is shielded from the light receiving surface by closing the shutter 19. An optical unit driver 20 drives the diaphragm 18 and the shutter 19 so that the aperture ratio can be adjusted and the shutter 19 can be opened and closed, respectively.

The imaging device 12 is electrically connected to the CPU 14 via the AFE 13. A clock signal is sent from the CPU 14 to the AFE 13. The AFE 13 generates a frame signal and an imaging device driving signal based on the received clock signal. The imaging device driving signal is sent to the imaging device 12. Incidentally, the frame signal determines a frequency per unit time for capturing an optical image by the imaging device. The imaging device 12 is driven based on the imaging device driving signal, which is used by the imaging device 12 to generate an image signal synchronized with the frame signal.

The generated image signal is sent to the AFE 13. The AFE 13 carries out correlated double sampling and gain adjustment on the image signal. In addition, the image signal is converted into image data, which is digital data. The image data is then sent to the CPU 14.

The CPU 14 is connected to a dynamic random access memory (DRAM) 21. The DRAM 21 provides work memory for signal processing carried out by the CPU 14. The image data sent to the CPU 14 is temporarily stored in the DRAM 21. The CPU 14 carries out predetermined signal processing on the image data stored in the DRAM 21.

The CPU 14 is connected to the LCD 16. The image data, having undergone predetermined signal processing, is next sent to the LCD 16, which is able to display an image corresponding to the received image data.

The LCD comprises a liquid crystal block 22 and a back light 23. Light emitted by the back light 23 is irradiated to the entire back face of the liquid crystal block 22. The liquid crystal block 22 comprises a plurality of pixels arranged in two dimensions. Transmittance of light irradiated to each pixel is adjustable. By adjusting the transmittance of light irradiated to each pixel according to the received image data, an image corresponding to the received image data is displayed on the LCD.

The CPU 14 is connected to a card-interface 24. A memory card (not depicted) can be connected to and disconnected from the card-interface 24. When a release operation, as described later, is carried out, the image data, having undergone predetermined signal processing, is stored in the memory card.

The CPU 14 is connected to the input block 15, where a user inputs commands to the digital camera 10. The input block 15 comprises a release button (not depicted), a cross-key (not depicted), a power button (not depicted), and other buttons.

By depressing the power button, power of the digital camera 10 is switched on and off.

The digital camera 10 has several modes of operation, such as a photographing mode to capture an optical image of an object, a display mode to display a captured optical image on the LCD 16, and a set-up mode to change certain conditions of the digital camera 10. The cross key is used for inputting various commands in each mode.

By depressing the release button halfway while in photographing mode, exposure adjustment and focusing operation are carried out. In the exposure adjustment, the aperture ratio of the diaphragm 18, a shutter speed, and a gain to multiply the image data are adjusted. Additionally in the focusing operation, the location of the focus lens (not depicted) comprised in the photographic optical system 11 is adjusted. Further, by fully depressing the release button, the release operations, such as opening and closing the shutter 21, capturing an optical image by the imaging device 12, and storing the image data in the memory card, are carried out.

When a user inputs a command to the input block 15 for carrying out a function of the digital camera 10, an input signal according to the input command is sent to the CPU 14. The CPU 14 controls certain operations according to the received input signal.

For example, when the operation mode of the digital camera 10 is changed to the display mode, the CPU 14 controls the operation of the memory card and the LCD 16, so that an image corresponding to image data stored in the memory card is displayed on the LCD 16. In addition, driving of the imaging device 12 is stopped while in display mode.

For another example, when the operation mode of the digital camera 10 is changed to the set-up mode, the CPU 14 controls the operation of the LCD 16 so that a set-up screen for setting the conditions of the digital camera 10 is displayed on the LCD 16. Incidentally, data corresponding to the set-up screen is stored in the ROM (not depicted). The CPU 16 orders the data corresponding to the set-up screen to be sent to the LCD 16. In addition, driving of the imaging device 12 is stopped in set-up mode, as it is in display mode.

For another example, when the operation mode of the digital camera 10 is changed to the photographing mode, the CPU 14 controls certain operations, as described below.

A thru-image is displayed on the LCD 16 in photographing mode. Incidentally, the thru-image is a real-time optical image of an object captured by the imaging device 12. In photographing mode, exposure adjustment and focusing operation are carried out by depressing the release button halfway, as described above. Further, in photographing mode, the release operation is carried out and image data is stored in the memory card, as described above. The control of each operation by the CPU 14 is explained below.

In photographing mode, a clock signal, of which frequency is 36 MHz, is sent from the CPU 14 to the AFE 13. When the AFE 13 receives the 36 MHz clock signal, the AFE 13 generates a frame signal, of which frequency is 30 Hz, and a driving signal corresponding to the 30 Hz frame signal. Incidentally, in photographing mode, the CPU 14 controls the optical unit driver 20 so that the shutter 19 is left open before the release button is fully depressed.

The imaging device 12 starts to capture the optical image of an object based on the imaging device driving signal, and then one frame of an image signal is generated. Incidentally, the frequency of the frame signal is the same as the frequency for generating one frame of an image signal. Consequently, one frame of an image signal is generated per 1/30 second.

The successively generated image signals are sent to the CPU 14 via the AFE 13 in order. The CPU 14 sends the image data to the LCD 16 after carrying out the predetermined signal processing on the received image signal. Accordingly, an image successively updated per 1/30 second is displayed as the thru-image on the LCD 16.

The release button is halfway or completely depressed at user's desired timing.

When the release button is depressed halfway, the CPU 14 starts the exposure adjustment and focusing operation. During the exposure adjustment, the intensity of the entire optical image of an object is measured first, then the aperture ratio of the diaphragm 18, the shutter speed, and the gain to multiply the image data are adjusted based on the measured intensity of the entire optical image. Incidentally, the intensity measurement is taken from the image data received from the AFE 13.

The aperture ratio, the shutter speed, and the gain corresponding to the light intensity are recorded in the ROM. The CPU 14 reads the aperture ratio, the shutter speed, and the gain for multiplication corresponding to the measured light intensity.

The CPU 14 is connected to the optical unit driver 20. The recorded aperture ratio and shutter speed data are sent from the CPU 14 to the optical unit driver 20. The optical unit driver 20 drives the diaphragm 18 so that the aperture ratio of the diaphragm 18 agrees with the recorded aperture ratio. The optical unit driver 20 sets the shutter speed, which is the period between the opening and closing of the shutter, to the recorded shutter speed.

In the focusing operation, first, contrast of the captured optical image is detected based on the image signal received by the CPU 14. Next, the CPU 14 orders the optical unit driver 20 to move the focus lens along the optical axis of the photographic optical system 11 and orders the imaging device to capture an optical image. Then, the contrast of the captured optical image is detected again. The movement of the focus lens, the capture of the optical image, and the detection of the contrast are repeated until the focus lens is moved to the position where the contrast of the optical image is greatest. By moving the focus lens, the focusing operation is carried out.

When the release button is fully depressed, the CPU 14 starts the release operation. In the release operation, the CPU 14 orders the AFE 13 to output the frame signal and the imaging device driving signal so that the imaging device 12 can capture the optical image of an object. Further, the CPU 14 controls the optical unit driver 20 so that the shutter 19 opens and closes at the set shutter speed. Further, in the release operation, the CPU 14 carries out predetermined signal processing for the image signal generated by the imaging device 12 capturing the optical image. The image data is stored in the memory card.

The digital camera 10 has a function for saving power. In the set-up mode, the function for saving power can be switched on and off. When the function for saving power is switched on, a power saving operation is carried out.

The power saving operation, which is carried out in photographing mode, is described below.

The CPU 14 is connected to a timer 25. The CPU 14 orders the timer 25 to start clocking when a predetermined command is input to the input block 15. The time clocked by the timer 25 is data sent to the CPU 14.

When the predetermined period of clocked time elapses, the CPU 14 starts the power saving operation, which is comprised of an adjustment of the interval used by the imaging device 12 to capture an optical image, and an adjustment of the luminous quantity of light emitted by the back light 23.

Incidentally, the time clocked by the timer 25 is reset when a new command is input to the input block 15. Accordingly, the power saving operation is carried out if a new command is not input during the predetermined time.

As described above, a thru-image based on an optical image captured every 1/30 second is displayed on the monitor 25 in photographing mode before carrying out the power saving operation. When the predetermined period of clocked time elapses, a clock signal, of which frequency is 18 MHz, is sent from the CPU 14 to the AFE 13. When the AFE 13 receives the 18 MHz clock signal, the AFE 13 generates a frame signal, of which frequency is 15 Hz, and an imaging device driving signal corresponding to the 15 Hz frame signal. The generated imaging device driving signal is then sent to the imaging device 12.

Accordingly, while the imaging device 12 receives the frame signal of which frequency is 15 Hz, the imaging device 12 captures the optical image of an object every 1/15 second. According to this capture frequency, a thru-image displayed on the LCD 16 is updated per 1/15 second. Accordingly, the interval of capturing an optical image after the predetermined time has elapsed is twice as long as the interval before the predetermined time elapses.

In addition, the CPU 14 controls the back-light driver 17 so that the luminous quantity of light emitted from the back light 23 is a first luminous quantity before carrying out the power saving operation in photographing mode. When the predetermined period of time clocked by the timer 25 elapses, the CPU 14 controls the back-light driver 17 so that the luminous quantity of light emitted from the back light 23 is a second luminous quantity that is lower than the first luminous quantity.

Accordingly, the thru-image is displayed more darkly after carrying out the power saving operation than before carrying out the power saving operation. Incidentally, the back light 23 is a light-emitting diode (LED), of which the luminous quantity is based on the electrical current supplied to it. The luminous quantity of light emitted from the back light 23 can be changed by changing the current flowing to the LED from a first current value to a second current value that is lower than the first current value.

When a new command is input to the input block 15, the time clocked by the timer 25 is reset, the timer 25 starts clocking the time again, the optical image of an object is captured every 1/30 second, and the back light 23 is driven to emit light, of which luminous quantity is the first luminous quantity.

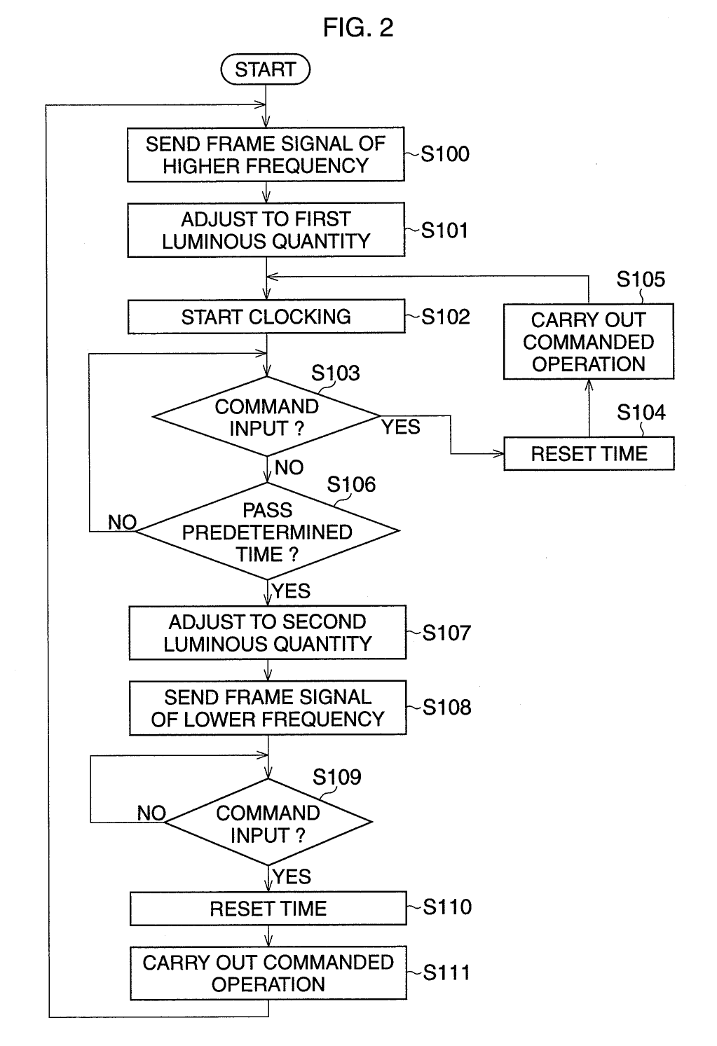

Next, the process that the CPU 14 and the AFE 13 carry out in the power saving operation is explained below, using the flowchart of FIG. 2.

The process starts when the photographing mode of the digital camera 10 is activated by either switching on power to the digital camera 10 or changing the operation mode to photographing mode. Incidentally, the process is repeated until power to the digital camera 10 is switched off or the operation mode is changed to something other than photographing mode.

At step S100, a clock signal, of which frequency is 36 MHz, is sent from the CPU 14 to the AFE 13. By receiving the clock signal of higher frequency, the imaging device driving signal corresponding to a frame signal of 30 Hz is sent from the AFE 13 to the imaging device 12. The imaging device 12 generates an image signal per 1/30 second to remain synchronized with the 30 Hz frame signal. The predetermined signal processing is carried out for the generated image signal, and the image data based on the image signal is sent to the LCD 16.

At step S101, the back light 23 is driven to emit light of which luminous quantity is the first luminous quantity. After adjusting the luminous quantity of the back light 23, the process proceeds to step S102, where the timer 25 is ordered to start clocking. At step S103, it is determined whether or not a predetermined command has been input to the input block 15.

When the predetermined command is input at step S103, the process proceeds to step S104. At step S104, the time clocked by the timer 25 is reset, and the process continues to step S105. At step S105, an operation according to the command input at step S103 is carried out. After carrying out the operation, the process returns to step S102, where the timer 25 starts clocking again.

When a command is not input at step S103, the process proceeds directly to step S106, where it is determined whether or not the elapsed time clocked by the timer 25 exceeds the predetermined period of time. When the elapsed time does not exceed the predetermined period of time, the process returns to step S103 and steps S103 and S106 are repeated until the elapsed time does exceed the predetermined period of time. When the elapsed time exceeds the predetermined period of time, the process continues to step S107.

At step S107, the back light 23 is driven to emit light of which luminous quantity is the second luminous quantity. After adjusting the luminous quantity of the back light 23, the process proceeds to step S108.

At step S108, the clock signal, of which frequency is 18 MHz, is sent from the CPU 14 to the AFE 13. Upon receiving the clock signal of lower frequency, the driving signal corresponding to a frame signal of 15 Hz is sent from the AFE 13 to the imaging device 12. The imaging device 12 generates an image signal per 1/15 second to remain synchronized with the 15 Hz frame signal. The predetermined signal processing is carried out for the generated image signal, and the image data based on the image signal is sent to the LCD 16.

After changing the frequency, the process goes to step S109. At step S109, it is determined whether or not a predetermined command has been input to the input block 15. If the predetermined command has not been input, the process returns to step S109 and step S109 is repeated until the predetermined command is input. When the predetermined command is input, the process proceeds to step S110. At step S110, the time clocked by the timer 25 is reset and the process continues to step S111.

At step S111, an operation according to the command input at step S109 is carried out. After carrying out the operation, the process returns to step S100 and the entire process is repeated.

In the above embodiment, when a command is not input in a certain period of time, the power saving operation, which includes lowering the frequency of the frame signal and lowering the luminous quantity of the light emitted from the back light 23, is carried out. Accordingly, power is conserved for the digital camera 10.

Further, when a new command is input during the power saving operation, the frequency of the frame signal and the luminous quantity of the LCD 16 are returned to the original frequency and luminous quantity. Accordingly, utility of the digital camera 10 is not lowered.

Further, the power saving operation can be suspended by de-selecting it in set-up mode. Accordingly, a reduction of the utility of the digital camera 10 is avoided by switching off the power saving function even if it takes a long time for a user to select an object or decide upon the moment to capture an optical image of an object.

The time clocked by the timer 25 is reset by inputting a new command in the above embodiment. However, power consumed by the digital camera 10 can be mitigated even if the time is not reset. Of course, it is preferable that the time is reset for maintaining utility of the digital camera 10, as described above.

The timer 25 starts clocking, not only when the operation mode is changed to the photographing mode, but also when switching on power of the digital camera 10 in the above embodiment. However, the timer 25 may start clocking only when a command, including the command for changing from the operation mode to the photographing mode, is input to the input block 15. It is generally desired to carry out an operation for capturing the optical image of an object or for displaying an image corresponding to stored image data as soon as power of the digital camera 10 is switched on. Accordingly, some commands are usually input as soon as power of the digital camera 10 is switched on and before the predetermined time has elapsed. Consequently, power consumption of the digital camera 10 can be mitigated even if the timer 25 does not start clocking soon after power of the digital camera 10 is switched on.

The luminous quantity of light emitted from the back light 23 of the LCD 16 is lowered for conserving power in the above embodiment. However, the luminous quantity may be kept at fixed level because power consumption of the digital camera 10 can be mitigated by adjusting the frequency of the frame signal.

The LCD 16 is used as a monitor in the above embodiment. However, another type of a monitor can be used to achieve the same effect as in the above embodiment if the luminous quantity of an applied monitor is adjustable. Even if the luminous quantity of an applied monitor is fixed, power consumption can be mitigated by adjusting the frequency of the frame signal.

The imaging device 12, which receives the frame signal, generates one frame of the image signal in the above embodiment. However, the same effect as the above embodiment can be achieved if the imaging device generates one field of the image signal.

The frequency of the frame signal is changed to 30 Hz or 15 Hz in the above embodiment, but it is not limited to 30 Hz or 15 Hz. The same effect can be achieved while carrying out the power saving function with a frame signal frequency that is lower than the frequency used during normal conditions.

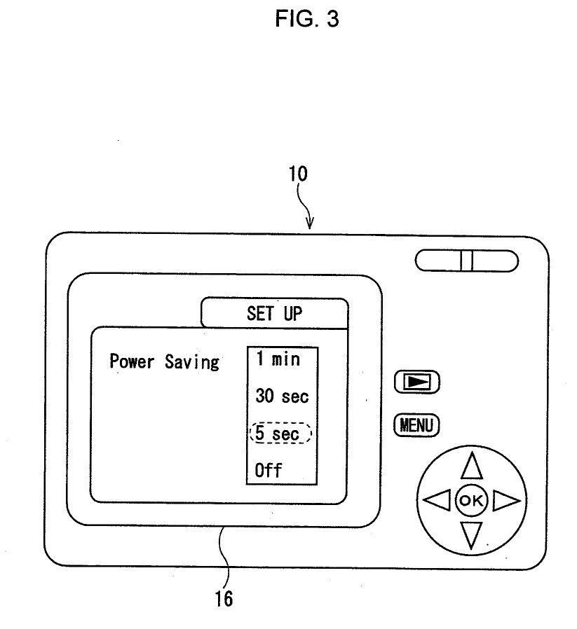

The power saving operation commences when the elapsed time clocked by the timer 25 exceeds the predetermined period of time in the above embodiment. However, the predetermined period of time may be modified in set-up mode. For example, as shown in FIG. 3, the predetermined period of time can be selected from a plurality of time periods, such as 1 minute, 30 seconds, or 5 seconds, from a screen for selecting the period of time before commencing the power saving function.

Although the embodiments of the present invention have been described herein with reference to the accompanying drawings, obviously many modifications and changes may be made by those skilled in this art without departing from the scope of the invention.

The present disclosure relates to subject matter contained in Japanese Patent Application No. 2006-043974 (filed on Feb. 21, 2006), which is expressly incorporated herein, by reference, in its entirety.

1. An imaging apparatus control unit, that controls an operation of an imaging apparatus, said imaging apparatus comprising an imaging device, said imaging device capturing an optical image of an object, said imaging apparatus control unit comprising:
a receiver that receives an input signal generated when a command, for ordering said imaging apparatus to carry out a predetermined function, is input;
a timer that starts clocking a time when said receiver receives said input signal; and
an imaging device driving unit that orders said imaging device to capture said optical image of said object once every first interval before a predetermined period of time clocked by said timer elapses, and that orders said imaging device to capture said optical image of said object once every second interval, which is longer than said first interval, after said predetermined period of time clocked by said timer has elapses.

2. An imaging apparatus control unit according to claim 1, wherein a time clocked by said timer is reset when said receiver receives new said input signal.

3. An imaging apparatus control unit according to claim 1, wherein said imaging device control unit comprises:
a frame signal generator that generates a frame signal, said frame signal determines a frequency per unit time for capturing said optical image; and
a cycle adjustment block that orders said frame signal generator to generate said frame signal of which cycle is said first interval before said predetermined period of time clocked by said timer elapses, and that orders said frame signal generator to generate said frame signal of which cycle is said second interval after said predetermined period of time clocked by said timer elapses.

4. An imaging apparatus control unit according to claim 1, wherein said timer starts clocking a time when power of said imaging apparatus is switched on.

5. An imaging apparatus control unit according to claim 1, further comprising a monitor controller that controls a monitor for displaying an image so that an image, which corresponds to said optical image of said object captured by said imaging device, is displayed more darkly after said predetermined period of time clocked by said timer elapses than before said predetermined period of time clocked by said timer elapses.

6. An imaging apparatus control unit according to claim 1, wherein said imaging device control unit orders said imaging device to continue capturing once every said first interval when a command for suspending an interval change is input to said input block.

7. An imaging apparatus control unit according to claim 5, wherein said imaging device control unit orders said imaging device to continue capturing once every said first interval and said monitor controller controls said monitor so that luminous quantity of an image displayed on said monitor is maintained at a first luminous quantity when a command for suspending an interval change is input to said input block.

8. A digital camera, comprising:
an imaging device that captures an optical image of an object;
an input block to which a command, for ordering said digital camera to carry out a predetermined function, is input
a timer that starts clocking a time when said command is input to said input block; and
an imaging device driving unit that orders said imaging device to capture said optical image of said object once every first interval before a predetermined period of time clocked by said timer elapses, and that orders said imaging device to capture said optical image of said object once every second interval, which is longer than said first interval, after said predetermined period of time clocked by said timer has elapsed.
